(19) United States
(12) Patent Application Publication
(10) Pub. No.: US 2002/0060441 A1
(43) Pub. Date: May 23, 2002

(54) Device for adjusting front wheel of tricycle

(76) Inventor: Pin -Chieh Feng, Chang Hua Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/749,461

(22) Filed: Dec. 28, 2000

(30) Foreign Application Priority Data
Nov. 20, 2000 (TW) 89220111

(51) Int. Cl. B62K 1/00; B62K 3/00; B62K 5/00; B62K 7/00; B62K 9/00

(52) U.S. Cl. 280/282; 280/276

(57) ABSTRACT

A front wheel adjustment device of a tricycle comprises a front fork, a front wheel, and a shaft. The front fork comprises two side wings, with each being provided with a connection portion. The connection portion is provided with a through hole. The front wheel is provided at the center with a shaft hole. The pivot is received in the shaft hole of the front wheel and the through holes of the front fork.

### FIELD OF THE INVENTION

The present invention relates generally to a tricycle, and more particularly to a front wheel adjusting device of the tricycle.

### BACKGROUND OF THE INVENTION

As shown in FIG. 1, a prior art tricycle 1 comprises a handlebar frame 2, a front fork 3 fastened with the bottom end of the handlebar frame 2 for mounting a front wheel 6, two footboards 7 fastened at the front end with the handlebar frame 2, two rear wheels 8 pivoted to the rear ends of the two footboards 7, and a swiveling member 9 pivoted with the handlebar frame 2 and connected with the two footboards 7. The front fork 3 has two side wings 4 parallel to the longitudinal direction of the handlebar frame 2. Each side wing 4 is provided at the bottom end with a connection portion 5 for mounting the front wheel 6. The ground touching point 6a of the front wheel 6 is deviated from the rotation center of the handlebar frame 2 by a predetermined distance S. When a rider rotates the handlebar frame 2, the front portion of the tricycle 1 is tilted leftward and rightward in conjunction with the left-right change in center of gravity of the rider's body, thereby causing the tricycle 1 to move forward. The cruising speed of the tricycle 1 is directly proportional to the distance S referred to above. However, the tricycle 1 in high speed motion can not be controlled and maneuvered with ease. If the distance S is shortened, the tricycle 1 can be better controlled at the expense of the cruising speed of the tricycle 1.

### SUMMARY OF THE INVENTION

The primary objective of the present invention is to provide a tricycle with a front wheel adjustment device to overcome the dilemma described above.

The tricycle of the present invention comprises a handlebar frame, two footboards pivoted at the front end thereof with the handlebar frame, two rear wheels pivoted respectively to the rear ends of the two footboards, and a swiveling member pivoted with the handlebar frame and connected with the two footboards. The front wheel adjustment device comprises a front fork, a front wheel, and a pivot. The front fork comprises two side wings extending downward from the left side and the right side of the bottom end of the handlebar frame. The two side wings are provided at the free end thereof with a connection portion which is provided with a through hole. The front wheel is provided at the center thereof with a shaft hole. The pivot is received in the shaft hole of the front wheel and the through hole of the front fork such that both ends of the pivot are removably mounted on the front fork.

### BRIEF DESCRIPTION OF THE DRAWINGS

FIG. 1 shows a side schematic view of a tricycle of the prior art.

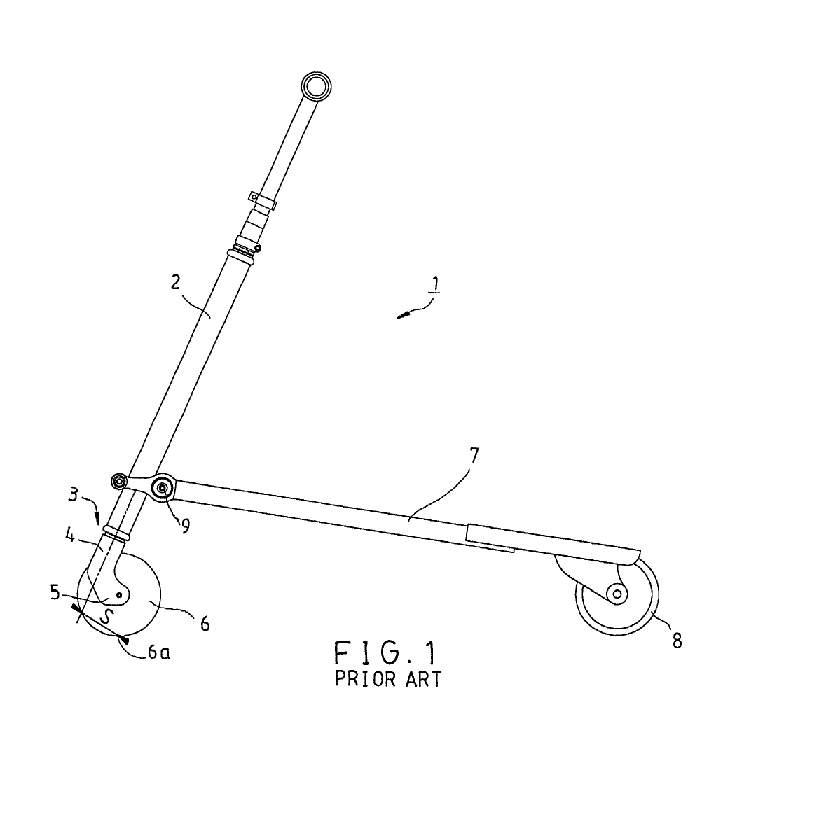

FIG. 2 shows a side schematic view of a preferred embodiment of the present invention.

FIG. 3 shows a side view of the front fork of the preferred embodiment of the present invention.

FIG. 4 shows a partial sectional view of the preferred embodiment of the present invention.

FIG. 5 shows an exploded view of the preferred embodiment of the present invention.

### DETAILED DESCRIPTION OF THE INVENTION

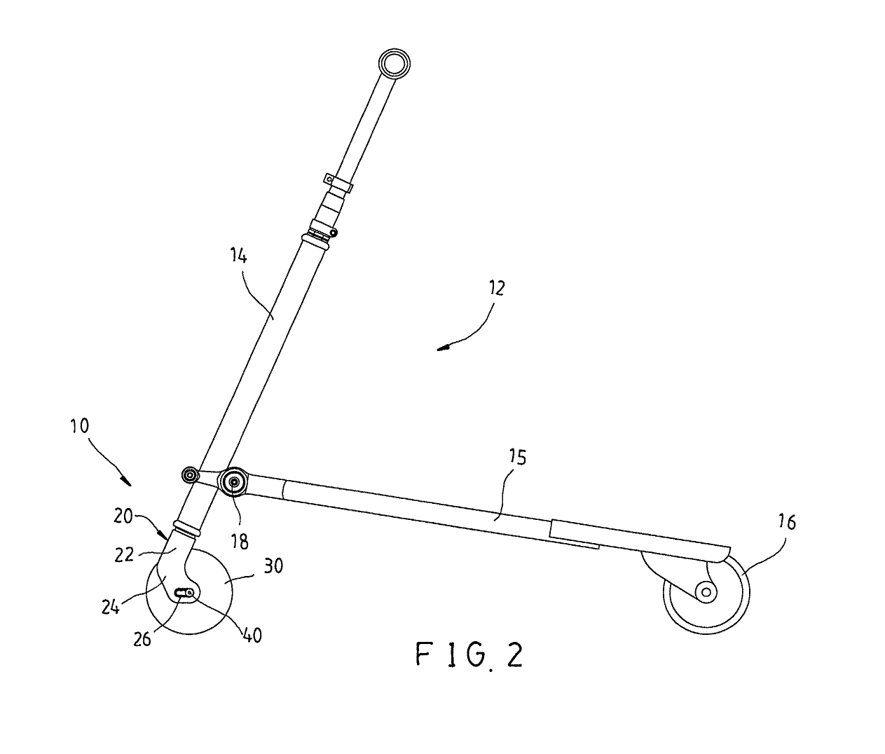

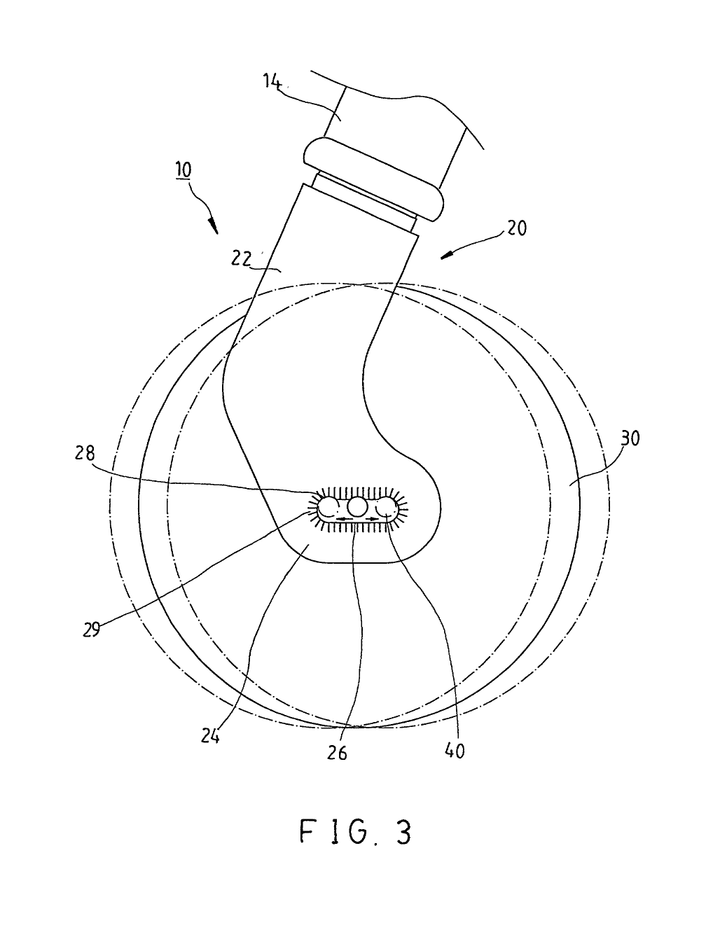

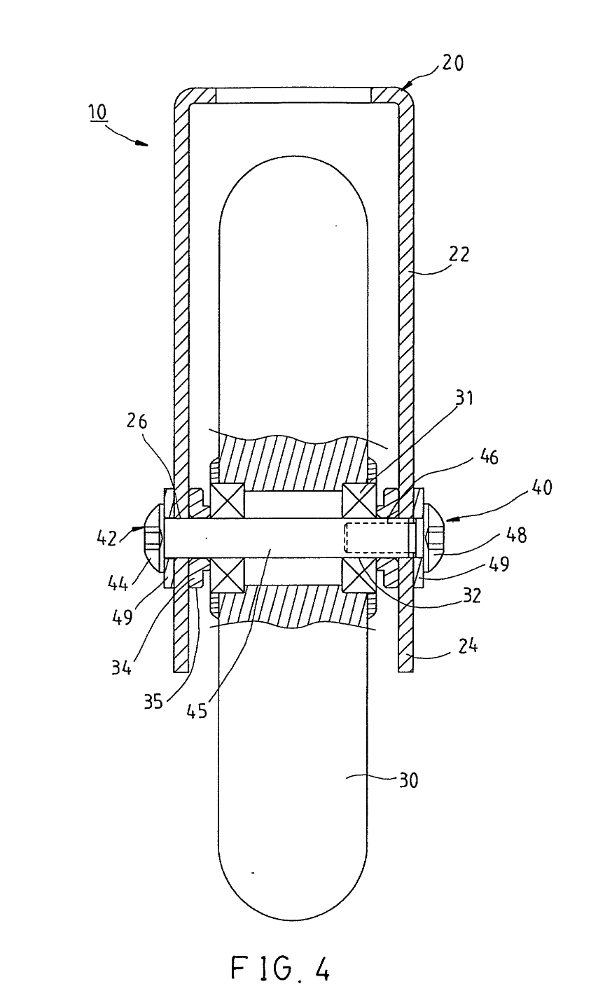

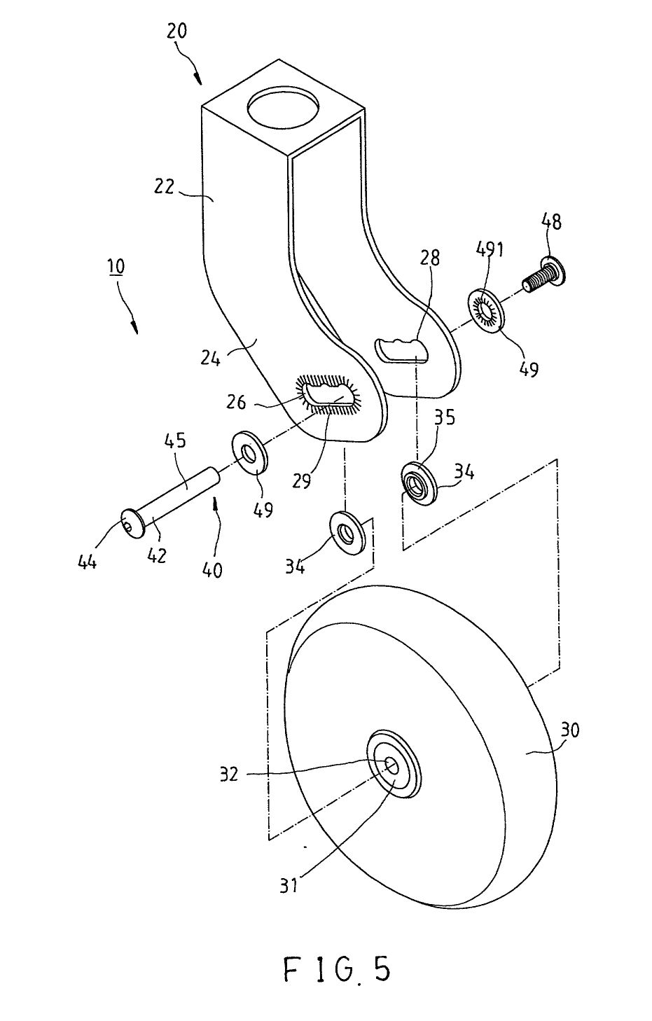

As shown in FIGS. 2-5, a front wheel adjustment device 10 embodied in the present invention is mounted on a tricycle 12, which comprises a handlebar frame 14, two footboards 15 pivoted at the front end thereof with the handlebar frame 14, two rear wheels 16 pivoted respectively to the rear end of the two footboards 15, and a swiveling member 18 pivoted to the handlebar frame 14 and connected with the footboards 15. The front wheel adjustment device 10 comprises a front fork 20, a front wheel 30, and a pivot 40.

The front fork 20 comprises two side wings 22 extending from the left side and the right side of the bottom end of the handlebar frame 15 along the longitudinal direction of the handlebar frame 15. The side wings 22 are provided at the bottom end with a connection portion 24 which is in turn provided with a through hole 26 extending horizontally and having at the top edge thereof three recessed portions 28 arranged equidistantly for insertion of the pivot 40. The through hole 26 is provided in the periphery thereof with an embossed area 29.

The front wheel 30 is provided at the center thereof with a bearing 31 which is in turn provided at the center with a shaft hole 32 for receiving the pivot 40. The front wheel 30 is provided in the left side and the right side with an urging member 34 which urges the inner side of the front fork 20. The urging member 34 is of a tubular construction. One end of the urging member 34 urges the inner edge of the bearing 31 to enable the front wheel 30 to turn freely in relation to the urging member 34. Other end of the urging member 34 is provided with a large diametrical portion 35 urging the inner edge of the front fork 20. The front wheel 30 is thus located in place between the two side wings 22 of the front fork 20.

The pivot 40 comprises a locking member 42 and a bolt 48. The locking member 42 has a head 44, a shank 45, and an inner threaded portion 46. The shank 45 is extended from the center of the head 44 and is received in the through hole 26 of the front fork 20 and the shaft hole 32 of the front wheel 30. The inner threaded portion 46 is located at the free end of the shank 45 and is engaged with the bolt 48, thereby enabling the front fork 20 and the pivot 40 to join together securely. The embossed portion 29 serves to provide friction. The pivot 40 and the front fork 20 may be provided therebedtween with two pads 49 which are in turn provided with an embossed portion 491 corresponding in location to the embossed portion 29 of the front fork 20. The pivot 40 and the front fork 20 are further secured in place.

The front wheel 30 is adjusted in its position by unfastening the locking member 42 and the bolt 48, so as to alter the operational characteristics of the tricycle 10. In order to prevent the incorrect adjustment of the front wheel 30, the two through holes 26 are provided in the top edge with three recessed portions 28. As the pivot 40 is inserted into the corresponding recessed portion 28, the front wheel 30 is located correctly. When the pivot 40 is received in the recessed portion 28, the weight of the tricycle forces the recessed portion 28 to press downward against the pivot 40, which is thus secured in place. The number of the recessed portion 28 may be three, or more or less than three.

What is claimed is:

1. A front wheel adjustment device of a tricycle comprising a handlebar frame, two footboards fastened at the front end with the handlebar frame, two rear wheels fastened with the rear ends of the two footboards, and a swiveling member pivoted with the handlebar frame and connected with the two footboards, said front wheel adjustment device comprising:
a front fork comprising two side wings extending from the bottom end of the handlebar frame, said two side wings being provided at a free end thereof with a connection portion which is provided with a through hole;
a front wheel provided at the center with a shaft hole; and
a pivot received in said shaft hole of said front wheel and said through holes of said front fork.

2. The device as defined in claim 1, wherein said through hole of said front fork is of an oblong construction.

3. The device as defined in claim 1, wherein said through hole is provided in a top edge with a plurality of recessed portions for insertion of said pivot.

4.The device as defined in claim 3, wherein said recessed portions are preferably three in number.

5. The device as defined in claim 1, wherein said through hole of said front fork is provided in the periphery with an embossed area.

6. The device as defined in claim 1, wherein said pivot comprises a locking member and a bolt, said locking member comprising a head, a shank extending from the center of said head such that said shank is received in said shaft hole and said through hole, and an inner threaded portion located at a free end of said shank and engaged with said bolt.

7. The device as defined in claim 1, wherein the longitudinal direction of said through hole is horizontally extended.
